(19) United States
(12) Patent Application Publication
(10) Pub. No.: US 2026/0136449 A1
(43) Pub. Date: May 14, 2026

(54) PROCESSING METHOD OF TARGET SUPPLY DEVICE AND ELECTRONIC DEVICE MANUFACTURING METHOD

(71) Applicant: GIGAPHOTON INC., Tochigi (JP)

(72) Inventors: Masaru ENDO, Oyama-shi (JP); Masaki NAKANO, Oyama-shi (JP)

(73) Assignee: GIGAPHOTON INC., Tochigi (JP)

(21) Appl. No.: 19/350,861

(22) Filed: Oct. 6, 2025

(30) Foreign Application Priority Data
Nov. 14, 2024 (JP) 2024-199221

(51) Int. Cl. H05G 2/00

(52) U.S. Cl. CPC H05G 2/0023; H05G 2/0027

(57) ABSTRACT

A processing method of a target supply device is configured to supply a target into a chamber for generating EUV light. The target supply device includes a tank capable of accommodating the target, a filter accommodated in the tank, and a nozzle in communication with inside of the tank and capable of discharging the target in a molten state. The processing method includes a first step of heating the tank to a temperature exceeding a melting point of the target before supplying the target into the tank, and a second step of supplying the target into the tank after the first step.

### CROSS-REFERENCE TO RELATED APPLICATIONS

The present application claims the benefit of Japanese Patent Application No. 2024-199221, filed on Nov. 14, 2024, the entire contents of which are hereby incorporated by reference.

### BACKGROUND

### 1. Technical Field

The present disclosure relates to a processing method of a target supply device, and an electronic device manufacturing method.

### 2. Related Art

Recently, miniaturization of a transfer pattern in optical lithography of a semiconductor process has been rapidly proceeding along with miniaturization of the semiconductor process. In the next generation, microfabrication at 10 nm or less will be required. Therefore, it is expected to develop a semiconductor exposure apparatus that combines an apparatus for generating extreme ultraviolet (EUV) light having a wavelength of about 13 nm with a reduced projection reflection optical system.

As the EUV light generation apparatus, a laser produced plasma (LPP) type apparatus using plasma generated by irradiating a target substance with laser light has been developed.

### LIST OF DOCUMENTS

### Patent Documents

Patent Document 1: Japanese Patent No. 6513106
Patent Document 2: Japanese Patent Application Publication No. 2023-011243

### SUMMARY

A processing method of a target supply device according to an aspect of the present disclosure is a processing method of a target supply device configured to supply a target into a chamber for generating EUV light. Here, the target supply device includes a tank capable of accommodating the target, a filter accommodated in the tank, and a nozzle in communication with inside of the tank and capable of discharging the target in a molten state. The processing method includes a first step of heating the tank to a temperature exceeding a melting point of the target before supplying the target into the tank, and a second step of supplying the target into the tank after the first step.

An electronic device manufacturing method according to an aspect of the present disclosure includes outputting EUV light generated by an EUV light generation apparatus to an exposure apparatus, and exposing a photosensitive substrate to the EUV light in the exposure apparatus to manufacture an electronic device. Here, the EUV light generation apparatus includes a chamber in which a target supplied therein is irradiated with laser light to generate the EUV light, and target supply device configured to supply the target into the chamber. The target supply device includes a tank capable of accommodating the target, a filter accommodated in the tank, and a nozzle in communication with inside of the tank and capable of discharging the target in a molten state. The target supply device has a process performed, the process including a first step of heating the tank to a temperature exceeding a melting point of the target before supplying the target into the tank, and a second step of supplying the target into the tank after the first step.

An electronic device manufacturing method according to an aspect of the present disclosure includes inspecting a defect of a mask by irradiating the mask with EUV light generated by an EUV light generation apparatus, selecting a mask using a result of the inspection, and exposing and transferring a pattern formed on the selected mask onto a photosensitive substrate. Here, the EUV light generation apparatus includes a chamber in which a target supplied therein is irradiated with laser light to generate the EUV light, and a target supply device configured to supply the target into the chamber. The target supply device includes a tank capable of accommodating the target, a filter accommodated in the tank, and a nozzle in communication with inside of the tank and capable of discharging the target in a molten state. The target supply device has a process performed, the process including a first step of heating the tank to a temperature exceeding a melting point of the target before supplying the target into the tank, and a second step of supplying the target into the tank after the first step.

### BRIEF DESCRIPTION OF THE DRAWINGS

Embodiments of the present disclosure will be described below merely as examples with reference to the accompanying drawings.

FIG. 1 is a diagram schematically showing the configuration of an LPP EUV light generation apparatus.

FIG. 2 is a sectional view showing the configuration of a target supply device according to a comparative example.

FIG. 3 is a main flowchart showing operation of the target supply device according to the comparative example.

FIG. 4 is a flowchart showing a processing procedure of baking of the target supply device according to the comparative example.

FIG. 5 is a timing chart according to the comparative example.

FIG. 6 is a diagram schematically showing a state of a tank before being heated according to the comparative example.

FIG. 7 is a diagram schematically showing a state of the tank after being heated according to the comparative example.

FIG. 8 is a flowchart showing operation of the target supply device according to a first embodiment.

FIG. 9 is an example of a timing chart according to the first embodiment.

FIG. 10 is a diagram schematically showing a state of the tank after being heated according to the first embodiment.

FIG. 11 is a flowchart showing an example of the processing procedure of baking of the target supply device according to a second embodiment.

FIG. 12 is an example of a timing chart according to the second embodiment.

FIG. 13 is a diagram showing a usage example of a baking dedicated chamber.

FIG. 14 is a diagram schematically showing the configuration of an exposure apparatus.

FIG. 15 is a diagram schematically showing the configuration of an inspection apparatus.

### DESCRIPTION OF EMBODIMENTS

### <Contents>

1. Overall description of EUV light generation system
   1.1 Configuration
   1.2 Operation
2. Target supply device of comparative example
   2.1 Configuration
   2.2 Operation
   2.3 Problem
3. Target supply device of first embodiment
   3.1 Configuration
   3.2 Operation
   3.3 Effect
4. Target supply device of second embodiment
   4.1 Configuration
   4.2 Operation
   4.3 Effect
5. Modification
6. Others

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### 1. Overall Description of EUV Light Generation System

### 1.1 Configuration

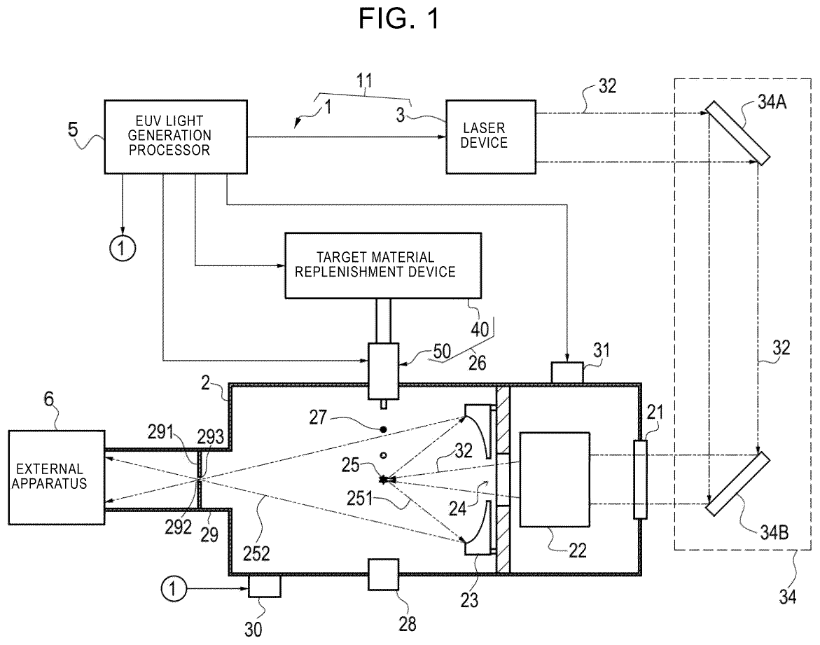

FIG. 1 schematically shows the configuration of an LPP EUV light generation system 11. An EUV light generation apparatus 1 is used with at least one laser device 3. In the present disclosure, a system including the EUV light generation apparatus 1 and the laser device 3 is referred to as the EUV light generation system 11. As shown in FIG. 1 and described in detail below, the EUV light generation apparatus 1 includes a chamber 2 and a target supply device 26. The chamber 2 is configured sealable. The target supply device 26 includes a target material replenishment device 40 and a target generation device 50. The target material replenishment device 40 supplies the material of the target 27 to the target generation device 50. The target generation device 50 generates the target 27 from the material of the target 27, and discharges the target 27 into the chamber 2. For example, the target generation device 50 is attached so that a part thereof penetrates a wall of the chamber 2. The material of the target 27 includes tin. The material of the target 27 may also include a combination of tin and terbium, gadolinium, lithium, or xenon.

At least one through hole is formed in the wall of the chamber 2. The through hole is provided with a window 21. Pulse laser light 32 output from the laser device 3 is transmitted through the window 21. In the chamber 2, for example, a laser light concentrating optical system 22 and an EUV light concentrating mirror 23 are arranged. The laser light concentrating optical system 22 concentrates the pulse laser light 32 on a plasma generation region 25. The EUV light concentrating mirror 23 has a spheroidal reflection surface and has first and second focal points. A multilayer reflection film in which, for example, molybdenum and silicon are alternately stacked is formed on a surface of the EUV light concentrating mirror 23. The EUV light concentrating mirror 23 is arranged, for example, such that the first focal point is located in the plasma generation region 25 and the second focal point is located at an intermediate focal point (IF) 292. A through hole 24 is formed at the center of the EUV light concentrating mirror 23. The Pulse laser light 32 passes through the through hole 24. The pulse laser light 32 is an example of the “laser light” according to the technology of the present disclosure.

Further, the EUV light generation apparatus 1 includes a connection portion 29 providing communication between the inside of the chamber 2 and the inside of an external apparatus 6. A wall 291 in which an aperture 293 is formed is arranged in the connection portion 29. The wall 291 is arranged such that the aperture 293 is located at the second focal point of the EUV light concentrating mirror 23. The external apparatus 6 is an exposure apparatus or an inspection apparatus that uses EUV light generated by the EUV light generation apparatus 1.

Further, the EUV light generation apparatus 1 includes an EUV light generation processor 5, a laser light travel direction control unit 34, the laser light concentrating optical system 22, a target collection unit 28, a gas supply device 31, and a gas exhaust device 30. The laser light travel direction control unit 34 includes, for example, optical elements 34A, 34B for defining the travel direction of the pulse laser light and actuators for adjusting the position, posture, and the like of the optical element 34A, 34B. The target collection unit 28 collects the target 27 discharged by the target generation device 50. The gas supply device 31 supplies an inert gas into the chamber 2. The gas exhaust device 30 exhausts the inert gas in the chamber 2.

### 1.2 Operation

As shown in FIG. 1, the pulse laser light 32 output from the laser device 3 is transmitted through the window 21 via the laser light travel direction control unit 34, and enters the chamber 2. The pulse laser light 32 travels along at least one optical path in the chamber 2, is reflected by the EUV light concentrating mirror 23, and is radiated to the target 27.

The target generation device 50 melts the material of the target 27 and discharges the molten target 27 as a droplet toward the plasma generation region 25 in the chamber 2. The target 27 is irradiated with at least one pulse included in the pulse laser light 32. The target 27 irradiated with the pulse laser light 32 is turned into plasma, and radiation light 251 is radiated from the plasma. The EUV light concentrating mirror 23 reflects EUV light 252 contained in the radiation light 251 at higher reflectance than light in other wavelength ranges. The EUV light 252 reflected by the EUV light concentrating mirror 23 is concentrated on the intermediate focal point 292 and output to the external apparatus 6. Here, one target 27 may be irradiated with a plurality of pulses included in the pulse laser light 32.

The EUV light generation processor 5 controls the entire EUV light generation system 11. The EUV light generation processor 5 controls, for example, the timing at which the target 27 is output through the target supply device 26. Further, the EUV light generation processor 5 controls, for example, the oscillation timing of the laser device 3, the travel direction of the pulse laser light 32, the concentration position of the pulse laser light 32, and the like. Further, the above-described various kinds of control are merely examples, and other control may be added to the EUV light generation processor 5 as necessary.

### 2. Target Supply Device of Comparative Example

### 2.1 Configuration

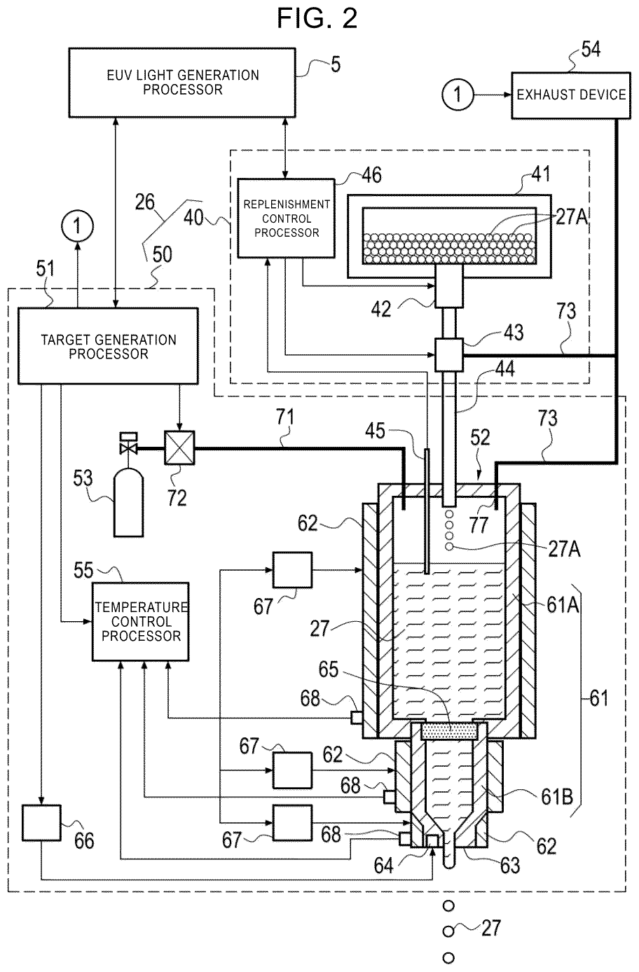

FIG. 2 is a diagram showing the configuration of the target supply device 26 according to the comparative example. In the target supply device 26, the target generation device 50 includes a target generation processor 51, a droplet supply unit 52, an inert gas supply unit 53, an exhaust device 54, and a temperature control processor 55.

The target generation processor 51 controls the target generation device 50. The droplet supply unit 52 includes a melting tank 61, heaters 62, a nozzle 63, a piezoelectric element 64, a filter 65, and the temperature control processor 55. The melting tank 61 is a tank for melting the material of the target 27 (hereinafter referred to as target material 27A) and accommodating the molten target 27. The melting tank 61 includes a large tank 61A and a small tank 61B having a smaller capacity than the large tank 61A. The target material replenishment device 40 is connected to the large tank 61A, and the small tank 61B is provided at the downstream side of the large tank 61A. The nozzle 63 is provided at the downstream side of the small tank 61B. At the melting tank 61, the heater 62 is provided to each of the large tank 61A and the small tank 61B. The heaters 62 are, for example, a jacket type that is attached to the outer circumference of the melting tank 61 in a winding manner. The melting tank 61 is heated by the heaters 62, and the target material 27A in the melting tank 61 is melted. The melting tank 61 is an example of the “tank” according to the technology of the present disclosure. The melting tank 61 is hereinafter simply referred to as a tank 61.

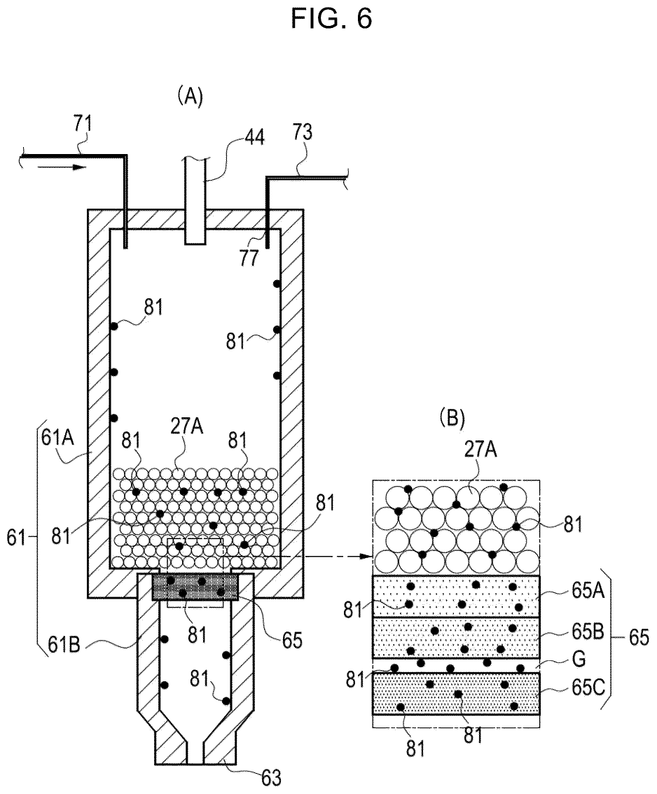

The filter 65 is accommodated in the tank 61. For example, the filter 65 is arranged in the vicinity of the boundary between the large tank 61A and the small tank 61B. The molten target 27 passes through the filter 65 from the large tank 61A and flows into the small tank 61B and the nozzle 63. The heater 62 is also provided around the nozzle 63. The filter 65 removes impurities contained in the target 27. The filter 65 is formed of porous material, and as will be described later, for example, has a configuration in which a plurality of filter layers having different pore diameters are laminated (see FIG. 6). The impurities are particles containing tin oxide and the like included in the molten target 27.

At the nozzle 63, the piezoelectric element 64 is arranged in the vicinity of a nozzle hole. The piezoelectric element 64 is connected to a piezoelectric power source 66 that supplies drive power to the piezoelectric element 64. The target generation processor 51 inputs a drive signal having a preset drive frequency to the piezoelectric element 64 via the piezoelectric power source 66. The piezoelectric element 64 vibrates the nozzle 63 in accordance with the input drive signal. The target 27 flowing into the nozzle hole is in a state of extending in a columnar shape toward the inside of the chamber 2 due to a differential pressure between the pressure in the tank 61 and the pressure in the chamber 2. When the nozzle 63 vibrates in this state, the target 27 in a columnar shape is divided into droplets, and the target 27 is discharged into the chamber 2 as droplets.

The heaters 62 are connected to a heater power source 67 that supplies the drive power to the heater 62. A temperature sensor 68 is provided at each of the heaters 62, and the temperature sensor 68 inputs the measured temperature to the temperature control processor 55.

The temperature control processor 55 controls the temperature of each of the tank 61 and the nozzle 63 through the heater power source 67 and the temperature sensors 68. The temperature control processor 55 controls driving of the heaters 62 via the heater power source 67 based on the temperature measured by the temperature sensors 68. Accordingly, the temperature of each of the tank 61 and the nozzle 63 is controlled. For example, the temperature control processor 55 can individually control the heaters 62 provided at the large tank 61A, the small tank 61B, and the nozzle 63.

The main function of the heaters 62 is to melt the target 27 for EUV generation, but the heaters 62 are also used for baking of the filter 65. In the tank 61, moisture may adhere to and remain on an inner wall of the tank 61 in addition to the inside of the filter 65. The residual moisture reacts with tin contained in the molten target 27, so that tin oxide is generated. The tin oxide may clog the nozzle hole of the nozzle 63, and when the nozzle hole is clogged, the discharge speed of the target 27 discharged from the nozzle 63 as a droplet may decrease. Baking is a process of increasing the temperature in the tank 61 including the filter 65 in order to gasify and discharge the residual moisture to the outside of the tank 61. Baking is an example of the “process performed on the target supply device” according to the technology of the present disclosure.

The inert gas supply unit 53 supplies the inert gas into the tank 61. The inert gas supply unit 53 is, for example, a gas cylinder, and contains, as the inert gas, a high-pressure rare gas such as argon gas or helium gas as a pressurized gas. The inert gas supply unit 53 is connected to the large tank 61A via a supply pipe 71. A pressure regulator 72 is arranged at the supply pipe 71. The pressure regulator 72 regulates the gas pressure supplied from the inert gas supply unit 53.

The exhaust device 54 exhausts the gas in the tank 61. An opening 77 is provided in a wall surface of the large tank 61A, and an exhaust pipe 73 is attached to the opening 77. The exhaust device 54 is connected to the large tank 61A via the exhaust pipe 73. The target generation processor 51 controls the pressure in the tank 61 by controlling the pressure regulator 72 and the exhaust device 54. Further, the target generation processor 51 discharges the residual moisture gasified by baking to the outside of the tank 61 through the exhaust device 54.

The target material replenishment device 40 includes a replenishment tank 41, a material discharge mechanism 42, a load lock chamber 43, a material supply pipe 44, a liquid level sensor 45, and a replenishment control processor 46. The replenishment control processor 46 controls each unit of the target material replenishment device 40.

The replenishment tank 41 accommodates the target material 27A. The target material 27A is solid and, for example, spherical. The material discharge mechanism 42 includes, for example, a measurement instrument that measures a replenishment amount of the target material 27A. Based on an instruction from the replenishment control processor 46, the material discharge mechanism 42 discharges the measured replenishment amount of the target material 27A from the replenishment tank 41 to the load lock chamber 43.

The load lock chamber 43 is provided on the downstream side of the material discharge mechanism 42, and is connected to the large tank 61A via the material supply pipe 44. The load lock chamber 43 temporarily accommodates the target material 27A of a replenishment amount for one time to be discharged from the material discharge mechanism 42. The load lock chamber 43 replenishes the accommodated target material 27A to the large tank 61A based on an instruction from the replenishment control processor 46. The pressure in the load lock chamber 43 is adjusted due to control of the pressure regulator 72 and the exhaust device 54 through the material supply pipe 44, the exhaust pipe 73, and a valve (not shown).

The liquid level sensor 45 detects the liquid level of the molten liquid target 27 in the large tank 61A. The liquid level sensor 45 has, for example, a rod-like shape, and is arranged in a posture so that the longitudinal direction thereof is along the height direction of the large tank 61A. The liquid level sensor 45 outputs a detection signal to the replenishment control processor 46 when the liquid level of the liquid target 27 exceeds a preset target position. While the detection signal is input, the replenishment control processor 46 determines that replenishment of the target material 27A is unnecessary, and on the contrary, determines that replenishment is necessary when the liquid level is lowered and the input of the detection signal is interrupted.

When the target 27 is discharged from the nozzle 63, the liquid level of the liquid target 27 in the large tank 61A is lowered. The replenishment control processor 46 replenishes the target material 27A into the large tank 61A via the replenishment tank 41 and the load lock chamber 43 when it is determined that replenishment is necessary so that the liquid level of the liquid target 27 in the large tank 61A is maintained at or above the target position.

### 2.2 Operation

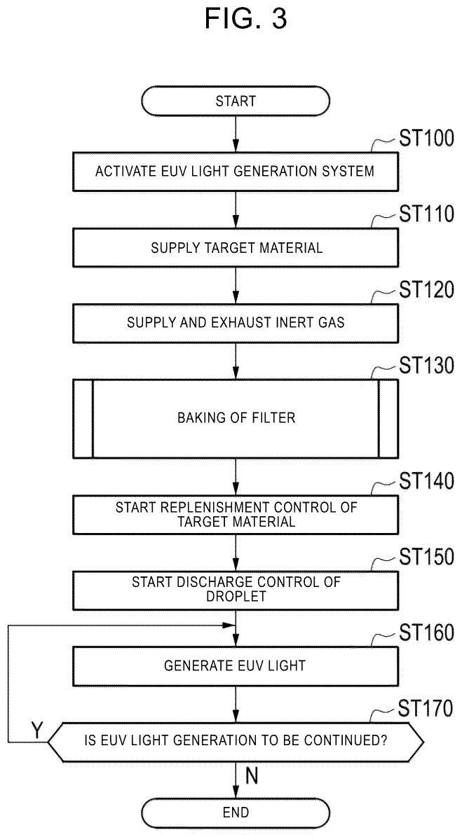

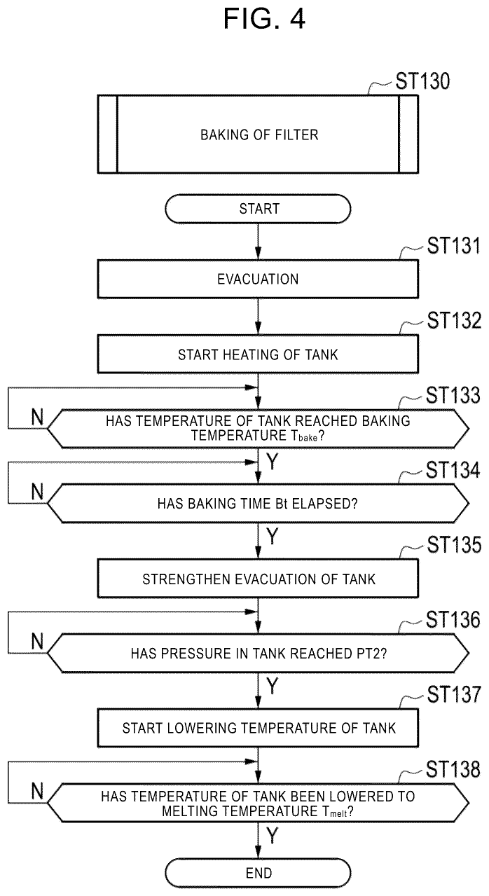

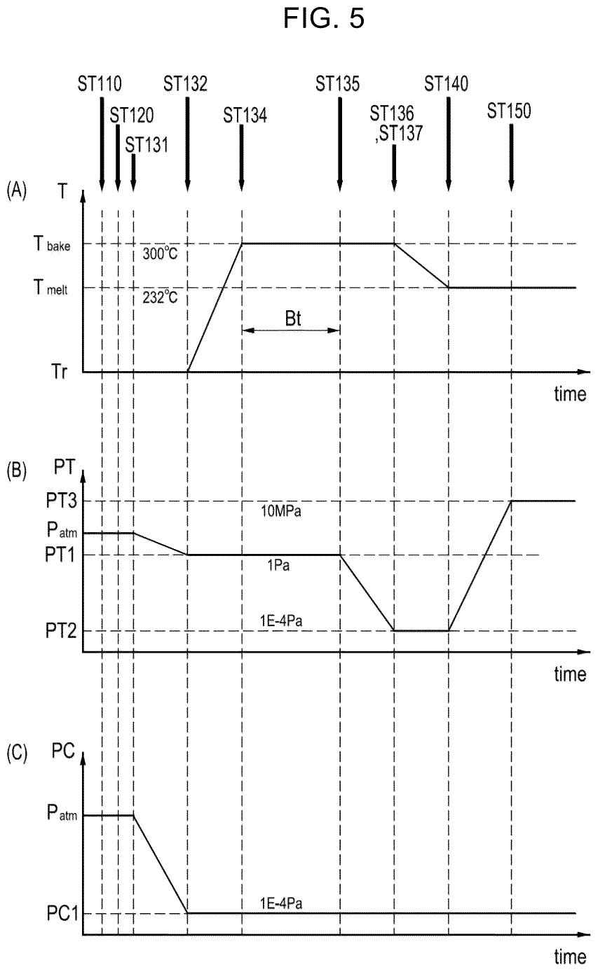

FIG. 3 is a main flowchart showing operation of the EUV light generation system 11. FIG. 4 is a flowchart showing processing of baking of the filter 65. FIG. 5 is a timing chart corresponding to the flowcharts of FIGS. 3 and 4. In FIG. 5, FIG. 5A shows a change over time of a temperature T in the tank 61, and FIG. 5B shows a change over time of a pressure PT in the tank 61. FIG. 5C shows a change over time of a pressure PC in the chamber 2.

In step ST100 of FIG. 3, the EUV light generation processor 5 activates the EUV light generation system 11 when an activation instruction is input. As shown in FIG. 5, each of the pressure PC in the chamber 2 and the pressure PT in the tank 61 are the atmospheric pressure Pₐₜₘ immediately after activation. Further, the pressure in the load lock chamber 43 is also the atmospheric pressure Pₐₜₘ.

The EUV light generation processor 5 proceeds to step ST110 in this state, and instructs the target supply device 26 to supply the target material 27A. Based on the instruction, the target supply device 26 supplies a predetermined amount of the target material 27A from the replenishment tank 41 to the large tank 61A in an empty state through control of the material discharge mechanism 42 and the load lock chamber 43.

In step ST120, the EUV light generation processor 5 instructs the target supply device 26 to supply and exhaust the inert gas to and from the tank 61. Accordingly, the supply of the inert gas from the inert gas supply unit 53 to the tank 61 is started. Further, in parallel with the supply of the inert gas, the exhaust device 54 exhausts the inert gas so that the pressure PT in the tank 61 is maintained. The supply of the inert gas lowers the oxygen concentration in the tank 61. The inert gas is supplied to suppress, during baking, generation of an oxide due to the oxidization with the residual moisture adhering to the surface of the target material 27A and to promote the gasification of the residual moisture adhering to the surface of the inner wall of the filter 65 and the tank 61.

After step ST120, the EUV light generation system 11 advances processing to step ST130. In step ST130, baking of the filter 65 is performed.

In step ST130, evacuation of the tank 61 and the chamber 2 of step ST131 of FIG. 4 is started. To prevent backflow from the chamber 2 to the tank 61, evacuation of the chamber 2 and evacuation of the tank 61 are simultaneously started, or evacuation of the chamber 2 is started before evacuation of the tank 61 is started. In the example shown in FIG. 5, evacuation of the tank 61 and evacuation of the chamber 2 are started simultaneously. Evacuation of the tank 61 is performed by the exhaust device 54 of the target supply device 26. The pressure PT in the tank 61 is reduced from the atmospheric pressure Pₐₜₘ to PT1. PT1 is, for example, 1 Pa (see FIG. 5). Even after evacuation of the tank 61 is performed, the supply of the inert gas to the tank 61 and the exhaust by the exhaust device 54 are continued. Evacuation of the chamber 2 is performed by the gas exhaust device 30 under the control of the EUV light generation processor 5. Evacuation of the chamber 2 is a process of reducing the pressure PC in the chamber 2 from the atmospheric pressure Pₐₜₘ to PC1, as shown in FIG. 5. PC1 is, for example, 1E-4 Pa.

In the tank 61, the gas escaping to the upstream side of the filter 65 is exhausted by the exhaust device 54 through the exhaust pipe 73 provided at the opening 77. On the other hand, the pressure in the chamber 2 is reduced by evacuation. Therefore, the gas escaping to the downstream side of the filter 65 flows into the chamber 2 through the nozzle 63 and is exhausted by the gas exhaust device 30. Accordingly, the water gasified by baking can be discharged from both the upstream side and the downstream side of the tank 61. In this state, heating of the tank 61 in step ST132 is started.

In step ST132, the target supply device 26 starts to heat the tank 61 by driving the heater 62. During the heating, for example, only the heater 62 at the large tank 61A is driven. Of course, the heater 62 at the small tank 61B may be also driven to heat from both the upstream side and the downstream side of the filter 65. When heating of the tank 61 is started, as shown in FIG. 5, the temperature T of the tank 61 starts to increase from a normal temperature Tr. The temperature T of the tank 61 is increased to T_{bake} which is a target temperature of baking (hereinafter, simply referred to as a baking temperature). The baking temperature T_{bake} is set to, for example, a temperature that exceeds a melting point Tₘₑₗₜ of the target material 27A in order to eliminate residual moisture in the tank 61 as much as possible. When the target material 27A is tin, as shown in FIG. 5, Tₘₑₗₜ is 232° C. and the baking temperature T_{bake} is set to, for example, 300° C. The baking temperature T_{bake} is determined in consideration of the heat resistant temperature of the components of the tank 61 and the like. That is, when the heat resistant temperature is Tₘₐₓ, the baking temperature T_{bake} is set within the range of Tₘₑₗₜ<T_{bake}<Tₘₐₓ.

When heating of the tank 61 is started, the target supply device 26 monitors the temperature T of the tank 61 in step ST133. When the temperature T reaches the baking temperature T_{bake} (i.e., 300° C.) (Y in step ST133), the target supply device 26 advances processing to step ST134 and starts measuring a baking time Bt. The baking time Bt is set to, for example, about 24 hours starting from the time when the tank 61 reaches the baking temperature T_{bake}. By the baking, the residual moisture in the tank 61 is gasified and discharged to the outside of the tank 61.

When the baking time Bt has elapsed (Y in step ST134), the target supply device 26 advances processing to step ST135 to strengthen evacuation of the tank 61. In step ST135, as shown in FIG. 5, the target supply device 26 decreases the pressure PT in the tank 61 from PT1 to PT2 through the exhaust device 54. Similarly to PC1 of the chamber, PT2 is, for example, 1E-4 Pa.

When it is determined that the pressure PT in the tank 61 has reached PT2 in step ST136, the target supply device 26 advances processing to step ST137. In step ST137, the target supply device 26 starts lowering the temperature T of the tank 61 from the baking temperature T_{bake} to the melting point Tₘₑₗₜ. When it is determined in step ST138 that the temperature T of the tank 61 has fallen to the melting point Tₘₑₗₜ, the target supply device 26 determines that step ST130 is completed, and processing returns to step ST140 of FIG. 3. Owing to that the temperature T of the tank 61 is lowered to the melting point Tₘₑₗₜ (step ST137 and step ST138) after baking, the lifetime of the heaters 62 can be extended.

The target supply device 26 starts replenishment control of the target material 27A as preparation for EUV light generation in step ST140. In the replenishment control, the target supply device 26 replenishes the target material 27A so that the liquid level of the molten target 27 in the tank 61 is maintained at the target position. In the comparative example, since there is step ST110 in which the target material 27A is supplied before baking of step ST130, the molten target 27 already exists in the tank 61 immediately after baking. The target supply device 26 determines whether or not replenishment is necessary based on the detection signal of the liquid level sensor 45, and supplies the target material 27A when necessary.

Further, in step ST140, the EUV light generation processor 5 increases the pressure PT in the tank 61 as preparation for EUV light generation. Specifically, the target supply device 26 increases the supply amount of the inert gas by the pressure regulator 72 to increase the pressure PT in the tank 61 to PT3. PT3 is, for example, 10 MPa. As a result, a differential pressure is generated between the tank 61 and the chamber 2, and the target 27 can be discharged through the nozzle 63.

Then, in step ST150, the EUV light generation processor 5 starts discharge control in which the target 27 is discharged into the chamber 2 as a droplet by vibrating the nozzle 63. In step ST160, the EUV light generation processor 5 generates the EUV light by causing the pulse laser light 32 to enter the chamber 2 from the laser device 3 based on a trigger signal from the external apparatus 6. In step ST170, EUV light generation is continued while the trigger signal from the external apparatus 6 is input.

### 2.3 Problem

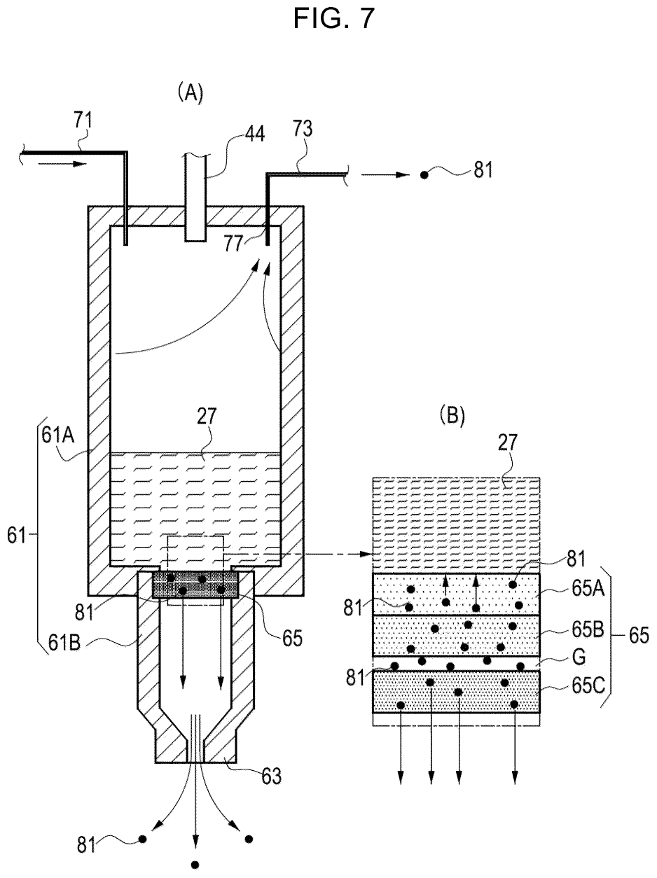

In the target supply device 26 according to the comparative example, baking is performed with the target material 27A supplied into the tank 61. Therefore, there is a problem that the discharge efficiency of the residual moisture cannot be improved even if the baking temperature T_{bake} is set to a temperature exceeding the melting point Tₘₑₗₜ. This problem will be described with reference to FIGS. 6 and 7. FIG. 6 shows a state before the tank 61 is heated in baking, and FIG. 7 shows a state after the tank 61 is heated. FIGS. 6A and 7A are general views of the tank 61, and FIGS. 6B and 7B are partial enlarged views around the filter 65. In FIGS. 6 and 7, the heaters 62, the liquid level sensor 45, and the like are omitted for convenience.

The filter 65 has, for example, a configuration in which filter layers 65A to 65C of three types of porous material having different pore diameters are laminated, and the pore diameters become smaller toward the nozzle 63. For example, the filter layers 65A, 65B are Shirasu porous glass filters and the filter layer 65C is a microchannel plate. Further, for example, a gap G is formed between the filter layer 65B and the filter layer 65C.

As shown in FIG. 6, residual moisture 81 adheres to the inner wall of the tank 61, the gap in the spherical target material 27A, and the pores in the filter 65. On the upper surface of the filter 65, the supplied target material 27A is deposited. When the tank 61 is heated in this state, the residual moisture 81 in the tank 61 is gasified and becomes bubbles. As shown in FIG. 7, on the upper side of the filter 65, the residual moisture 81 adhering to the inner wall of the tank 61 is discharged through the exhaust pipe 73. Until the temperature T of the tank 61 reaches the melting point Tₘₑₗₜ, the residual moisture 81 in the filter 65 escapes from the gap in the target materials 27A to the upper side of the filter 65, and is also discharged through the exhaust pipe 73.

However, when the temperature T of the tank 61 reaches the melting point Tₘₑₗₜ, the target material 27A melts, so that the molten target 27 covers the upper surface of the filter 65 as shown in FIG. 7. Further, a part of the molten target 27 enters the inside of the filter 65 and blocks the pores of the filter 65. Therefore, although the residual moisture 81 in the filter 65 escapes to the lower side of the filter 65 and is discharged from the nozzle 63, the residual moisture 81 cannot escape to the upper side of the filter 65 and is not discharged through the exhaust pipe 73. That is, even if the baking temperature T_{bake} is increased to a temperature exceeding the melting point Tₘₑₗₜ in order to improve the discharge efficiency of the residual moisture 81, in the comparative example, the discharge path to the upper side of the filter 65 is blocked by the molten target 27. Therefore, in the comparative example, there is a problem that an intended discharge efficiency cannot be obtained for discharge of the residual moisture 81.

### 3. Target Supply Device of First Embodiment

### 3.1 Configuration

The configuration of the target supply device 26 of a first embodiment is the same as that of the target supply device 26 of the comparative example, and is different only in the processing procedure related to baking. Therefore, description of the target supply device 26 will be omitted, and only the difference in the processing procedure will be described.

### 3.2 Operation

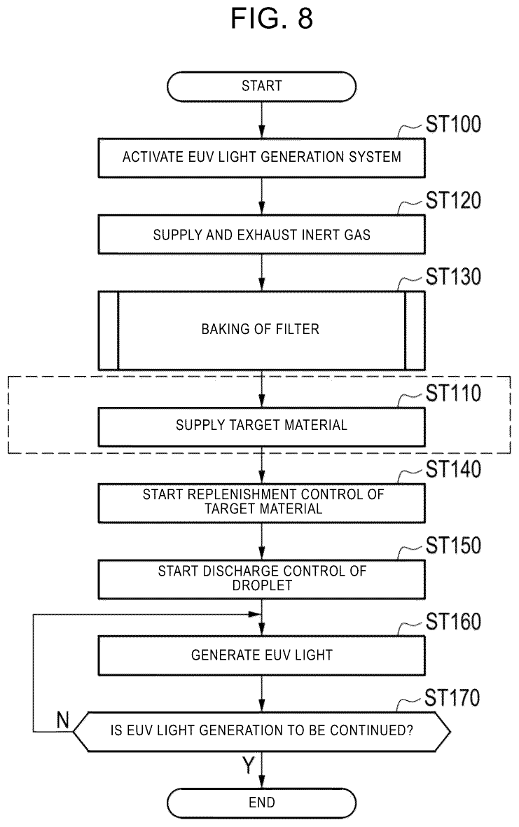

FIG. 8 is a flowchart showing the processing procedure of baking in the first embodiment. In the processing procedure of baking in the comparative example shown in FIG. 3, the target material 27A is supplied before baking in step ST130. In contrast, in the processing procedure in the first embodiment shown in FIG. 8, step ST110 of supplying the target material 27A is executed after baking in step ST130. In other respects, the first embodiment is the same as the comparative example.

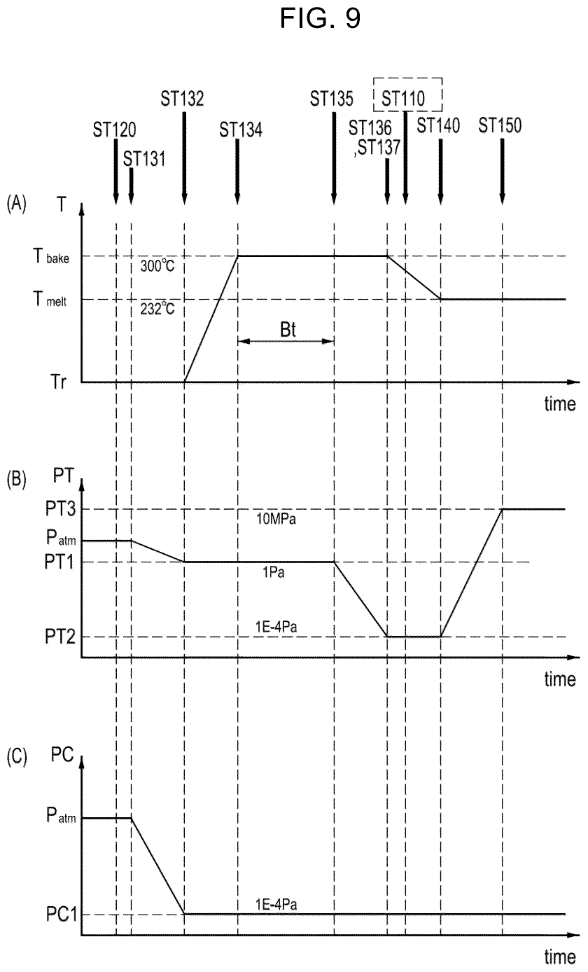

FIG. 9 is a timing chart corresponding to the processing procedure shown in FIG. 8. The difference between the timing chart shown in FIG. 9 and the timing chart of the comparative example shown in FIG. 5 is only the order of step ST110, and the others are the same. In FIG. 8, step ST132 to step ST135 included in step ST130 are an example of the “first step” according to the technology of the present disclosure, and step ST110 is an example of the “second step” according to the technology of the present disclosure.

### 3.3 Effect

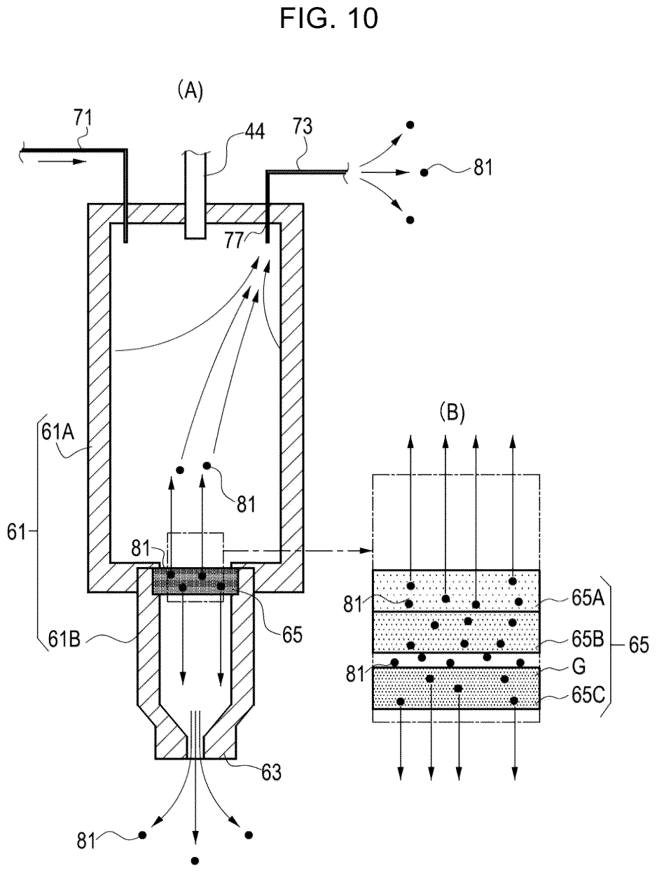

FIG. 10 is a diagram for explaining the effect of the first embodiment, shows the state of the tank 61 after heating in baking, and corresponds to FIG. 7 of the comparative example. Similarly to FIG. 7A, FIG. 10A is a general view of the tank 61, and similarly to FIG. 7B, FIG. 10B is a partial enlarged view around the filter 65 of the tank 61.

In the first embodiment, baking is performed before supplying the target material 27A into the tank 61. Therefore, in the first embodiment, even if the baking temperature T_{bake} is increased to a temperature exceeding the melting point Tₘₑₗₜ, the upper surface of the filter 65 is not covered with the molten target 27 as shown in FIG. 7 of the comparative example. Further, a part of the molten target 27 does not enter the inside of the filter 65 to block the pores of the filter 65. As a result, in baking, a discharge path of the residual moisture 81 escaping to the upper side of the filter 65 is secured. The higher the baking temperature T_{bake} is, the more the residual moisture 81 is gasified. The first embodiment has a higher discharge efficiency for the residual moisture 81 by increasing the baking temperature T_{bake} to a temperature exceeding the melting point Tₘₑₗₜ as compared with the comparative example. As a result, clogging of the nozzle hole caused by generation of tin oxide due to the residual moisture 81 is suppressed, and a decrease in the discharge speed of the target 27 is also suppressed, as compared with the comparative example.

### 4. Target Supply Device of Second Embodiment

### 4.1 Configuration

The configuration of the target supply device 26 of a second embodiment is the same as that of the target supply device 26 of the comparative example and the first embodiment, and is different only in the processing procedure related to baking. Therefore, description of the target supply device 26 will be omitted, and only the difference in the processing procedure will be described.

### 4.2 Operation

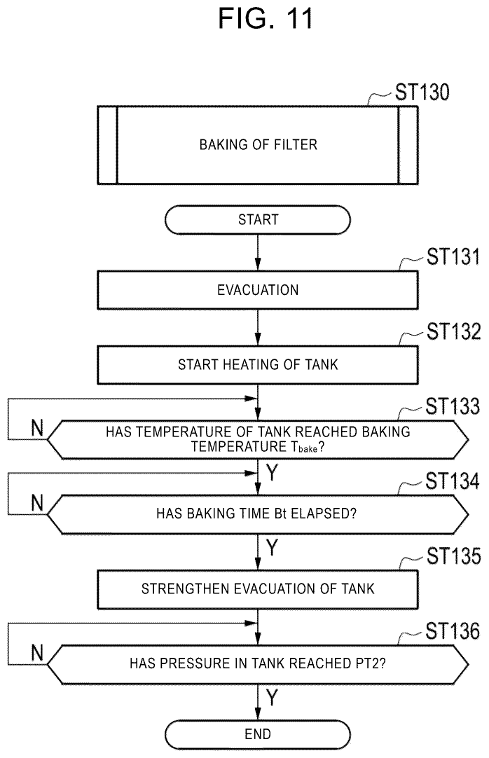

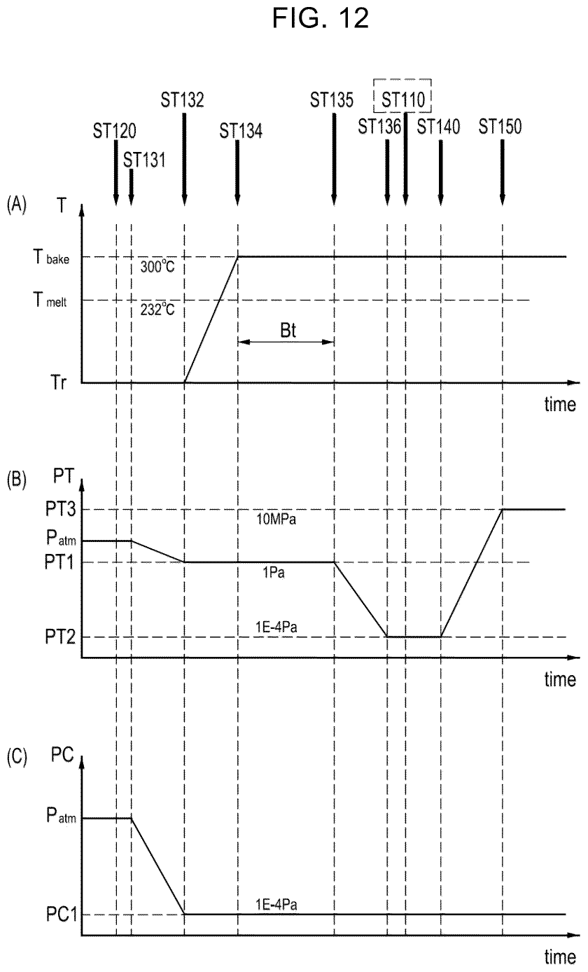

In the processing procedure of the second embodiment, a difference from the first embodiment is that the target material 27A is supplied while the temperature T of the tank 61 is maintained after baking in which the tank 61 is heated. That is, in the second embodiment, as shown in FIG. 11, step ST137 and step ST138 for lowering the temperature T of the tank 61 is not performed in step ST130. Therefore, as shown in the timing chart of FIG. 12, the temperature T of the tank 61 is maintained at the baking temperature T_{bake}. In the second embodiment, supplying of the target material in step ST110 of FIG. 8 and subsequent processing related to EUV light generation are executed in this state.

### 4.3 Effect

According to the second embodiment, since EUV light generation is performed at a temperature T of the tank 61 exceeding the melting point Tₘₑₗₜ, it is possible to suppress the risk of the melt failure of the target material 27A in the tank 61 as compared with the first embodiment.

### 5. Modification

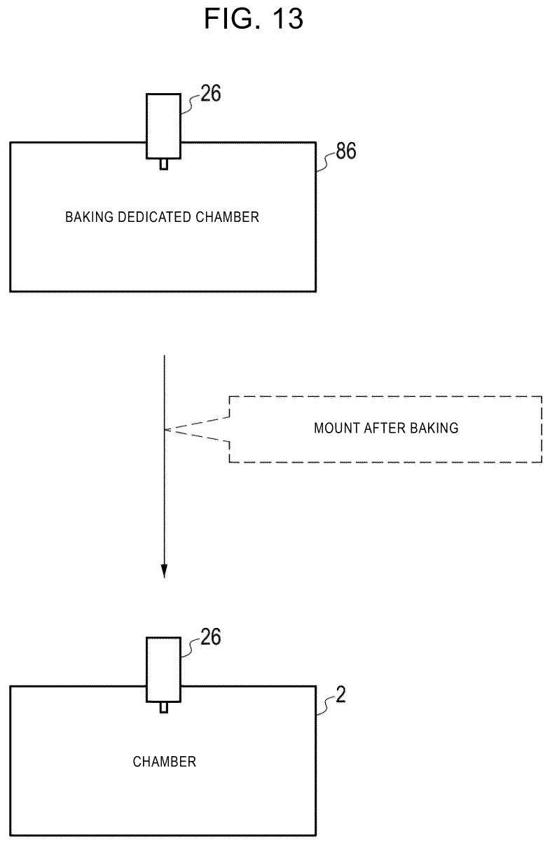

In the above-described embodiments, baking is performed with the target supply device 26 mounted on the chamber 2 for EUV light generation. However, as shown in FIG. 13, baking may be performed with the target supply device 26 mounted on a baking dedicated chamber 86. The baking dedicated chamber 86 includes, for example, the gas supply device 31 and the gas exhaust device 30, but is not provided with the EUV light concentrating mirror 23, the laser light concentrating optical system 22, and the like. After baking, the target supply device 26 subjected to baking is mounted in the chamber 2. If baking is performed with the target supply device 26 mounted on the chamber 2 as in the above-described embodiments, the baking dedicated chamber 86 is unnecessary. On the other hand, if the baking dedicated chamber 86 is used as in the modification, it is convenient to perform baking for a plurality of target supply devices 26 collectively in one baking dedicated chamber 86, for example.

### 6. Others

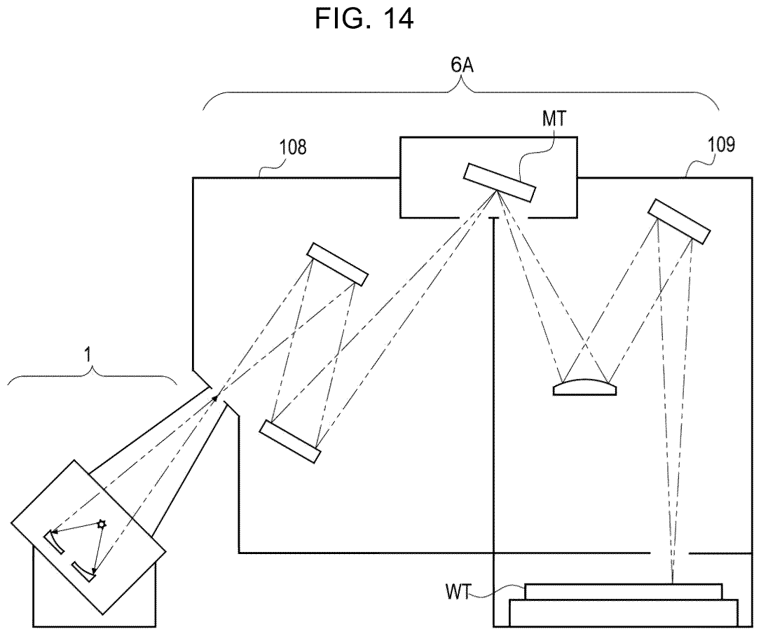

FIG. 14 schematically shows the configuration of an exposure apparatus 6A connected to the EUV light generation apparatus 1. The target supply device 26 subjected to baking with the processing method of the above-described embodiments is mounted on the EUV light generation apparatus 1 shown in FIG. 14. In FIG. 14, the exposure apparatus 6A as the external apparatus 6 includes a mask irradiation unit 108 and a workpiece irradiation unit 109. The mask irradiation unit 108 illuminates, via a reflection optical system, a mask pattern of the mask table MT with the EUV light incident from the EUV light generation apparatus 1. The workpiece irradiation unit 109 images the EUV light reflected by the mask table MT onto a workpiece (not shown) arranged on a workpiece table WT via a reflection optical system. The workpiece is a photosensitive substrate such as a semiconductor wafer on which photoresist is applied. The exposure apparatus 6A synchronously translates the mask table MT and the workpiece table WT to expose the workpiece to the EUV light reflecting the mask pattern. Through the exposure process as described above, a device pattern is transferred onto the semiconductor wafer, thereby an electronic device can be manufactured.

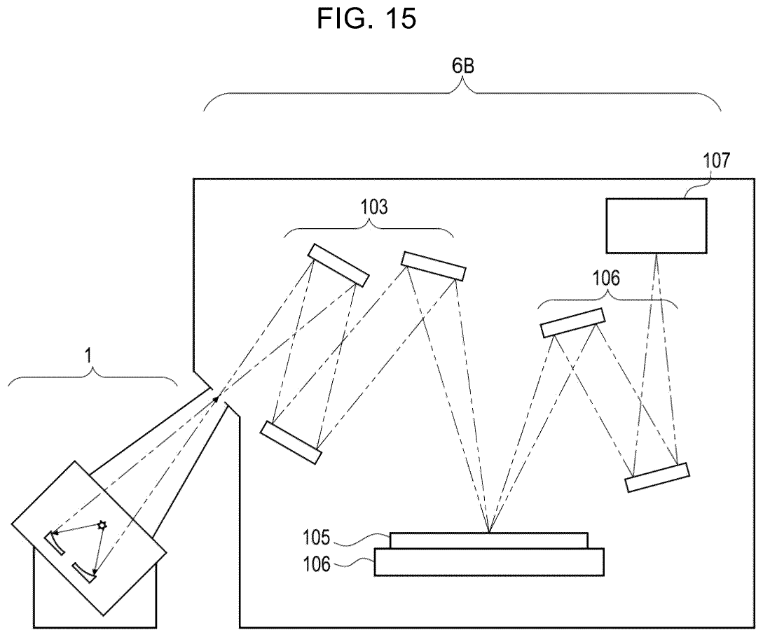

FIG. 15 schematically shows the configuration of an inspection apparatus 6B connected to the EUV light generation apparatus 1. The target supply device 26 subjected to baking with the processing method of the above-described embodiments is mounted on the EUV light generation apparatus 1 shown in FIG. 15. In FIG. 15, the inspection apparatus 6B as the external apparatus 6 includes an illumination optical system 103 and a detection optical system 106. The EUV light generation apparatus 1 outputs, as a light source for inspection, EUV light to the inspection apparatus 6B. The illumination optical system 103 reflects the EUV light incident from the EUV light generation apparatus 1 to illuminate a mask 105 placed on a mask stage 104. Here, the mask 105 conceptually includes a mask blanks before a pattern is formed. The detection optical system 106 reflects the EUV light from the illuminated mask 105 and forms an image on a light receiving surface of a detector 107. The detector 107 having received the EUV light acquires the image of the mask 105. The detector 107 is, for example, a time delay integration (TDI) camera. Inspection for a defect of the mask 105 is performed based on the image of the mask 105 obtained by the above-described steps, and a mask suitable for manufacturing an electronic device is selected using the inspection result. Then, the electronic device can be manufactured by exposing and transferring the pattern formed on the selected mask onto the photosensitive substrate using the exposure apparatus 6A.

The processor such as the EUV light generation processor 5, the target generation processor 51, the temperature control processor 55, and the replenishment control processor 46 may be physically configured as hardware to execute various processes included in the present disclosure. For example, the processor may be a computer including a memory that stores a control program defining the various processes and a processing device that executes the control program. The control program may be stored in one memory, or may be stored separately in a plurality of memories at physically separate locations, and the various processes may be defined by the control program as an aggregation thereof. The processing device may be a general-purpose processing device such as a central processing unit (CPU) or a special-purpose processing device such as a graphical processing unit (GPU).

Alternatively, the processor may be programmed as software to execute the various processes included in the present disclosure. For example, the processor may have a function of executing various processes implemented in a dedicated device such as an application specific integrated circuit (ASIC) or a programmable device such as a field programmable gate array (FPGA).

The various processes included in the present disclosure may be executed by one computer, one dedicated device, or one programmable device, or may be executed by cooperation of a plurality of computers, a plurality of dedicated devices, or a plurality of programmable devices at physically separate locations. The various processes may be executed by a combination including at least any two of: one or more computers, one or more dedicated devices, and one or more programmable devices.

The description above is intended to be illustrative and the present disclosure is not limited thereto. Therefore, it would be obvious to those skilled in the art that various modifications to the embodiments of the present disclosure would be possible without departing from the spirit and the scope of the appended claims.

Further, it would be also obvious to those skilled in the art that the embodiments of the present disclosure would be appropriately combined. The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more”. Further, “at least one of A, B, and C” should be interpreted to mean any of A, B, C, A+B, A+C, B+C, and A+B+C as well as to include combinations of the any thereof and any other than A, B, and C.

What is claimed is:

1. A processing method of a target supply device configured to supply a target into a chamber for generating EUV light,
the target supply device comprising a tank capable of accommodating the target, a filter accommodated in the tank, and a nozzle in communication with inside of the tank and capable of discharging the target in a molten state,
the processing method comprising:
a first step of heating the tank to a temperature exceeding a melting point of the target before supplying the target into the tank, and
a second step of supplying the target into the tank after the first step.

2. The processing method of the target supply device according to claim 1,
wherein the inside of the tank is subjected to exhaust in the first step and the second step.

3. The processing method of the target supply device according to claim 2,
wherein the exhaust is performed through the nozzle.

4. The processing method of the target supply device according to claim 3,
wherein the tank has an opening on a wall surface thereof, and the exhaust is performed through the opening as well.

5. The processing method of the target supply device according to claim 1,
wherein processing is performed with the target supply device mounted on the chamber.

6. The processing method of the target supply device according to claim 1,
wherein, after the first step, the second step is executed after lowering of a temperature of the tank is started.

7. The processing method of the target supply device according to claim 1,
wherein, after the first step, the second step is executed while a temperature of the tank is maintained.

8. The processing method of the target supply device according to claim 1,
wherein the target is tin, and the temperature exceeding the melting point is 300° C. or lower.

9. The processing method of the target supply device according to claim 1,
wherein an inert gas is supplied into the tank before the first step.

10. An electronic device manufacturing method, comprising:
outputting EUV light generated by an EUV light generation apparatus to an exposure apparatus; and
exposing a photosensitive substrate to the EUV light in the exposure apparatus to manufacture an electronic device,
the EUV light generation apparatus including:
a chamber in which a target supplied therein is irradiated with laser light to generate the EUV light; and
a target supply device configured to supply the target into the chamber,
the target supply device including a tank capable of accommodating the target, a filter accommodated in the tank, and a nozzle in communication with inside of the tank and capable of discharging the target in a molten state, and
the target supply device having a process performed, the process including a first step of heating the tank to a temperature exceeding a melting point of the target before supplying the target into the tank, and a second step of supplying the target into the tank after the first step.

11. An electronic device manufacturing method, comprising:
inspecting a defect of a mask by irradiating the mask with EUV light generated by an EUV light generation apparatus;
selecting a mask using a result of the inspection; and
exposing and transferring a pattern formed on the selected mask onto a photosensitive substrate,
the EUV light generation apparatus including:
a chamber in which a target supplied therein is irradiated with laser light to generate the EUV light; and
a target supply device configured to supply the target into the chamber,
the target supply device including a tank capable of accommodating the target, a filter accommodated in the tank, and a nozzle in communication with inside of the tank and capable of discharging the target in a molten state, and
the target supply device having a process performed, the process including a first step of heating the tank to a temperature exceeding a melting point of the target before supplying the target into the tank, and a second step of supplying the target into the tank after the first step.
